(19) United States
(12) Patent Application Publication
(10) Pub. No.: US 2010/0173132 A1
(43) Pub. Date: Jul. 8, 2010

(54) DECORATIVE SHEET

(76) Inventor: Raita Furukawa, Osaka (JP)

Correspondence Address: WENDEROTH, LIND & PONACK, L.L.P., 1030 15th Street, N.W.,, Suite 400 East, Washington, DC, 20005-1503, US

(21) Appl. No.: 12/596,256

(22) PCT Filed: Apr. 17, 2007
(86) PCT No.: PCT/JP2007/058364

§ 371 Date: Jan. 14, 2010

(51) Int. Cl. B32B 3/10

(52) U.S. Cl. 428/172

(57) ABSTRACT

The present invention provides a decorative sheet which is used in decoration of the surfaces of interior materials, furniture and fittings, home electric appliances, etc., and which, as visual and touch sensations on its surface, imparts a soft matt feeling with a sensation of unevenness and a soft feeling, and which is superior in abrasion resistance, scratch resistance and organic solvent resistance and can maintain the matt feeling for a prolonged period of time, ensuring excellent durability.

A decorative sheet 1, wherein a protective layer mainly composed of a transparent resin component is provided on the surface of a print layer 4 of a print sheet 5, the protective layer comprises a first protective layer 7 provided on the print layer 4 of the print sheet 5 and a second protective layer 9 containing transparent or semi-transparent spherical particles 8 and provided on given areas of the first protective layer 7, and the luster of the salient surface of the first protective layer is lower than the luster of the surface of the second protective layer.

### TECHNICAL FIELD

The present invention relates to a decorative sheet for use in decoration of the surfaces of interior material and fixture of buildings such as houses, building materials such as joinery products, furniture and fittings, household equipment, home electric appliances, etc., and more particularly to a decorative sheet which, as visual and touch sensations on its surface, imparts a soft matt feeling with a sensation of unevenness, and which is superior in abrasion resistance, scratch resistance and organic solvent resistance and can maintain the matt feeling for a prolonged period of time, ensuring excellent durability.

### BACKGROUND ART

Hitherto, the above-mentioned special decorative sheets have been manufactured by the printing methods described below.

The first method is a method of expressing a visual embossing effect by forming a woodgrain pattern on a substrate, forming a transparent or semi-transparent and shiny surface protection layer composed of a reactive curable resin layer on the woodgrain pattern, and forming a duct groove pattern layer formed from a matt ink composition on the surface protection layer (e.g., Patent Document 1).

Next, the second method is a method in which a woodgrain pattern layer is formed on a decorative paper, a transparent or semi-transparent surface protection layer composed of a reactive curable resin layer is formed on the woodgrain pattern layer, a duct groove pattern layer formed from a reactive curable ink is formed on the surface protection layer, and a register of a transparent or semi-transparent surface protection layer is aligned with the duct groove pattern layer using a printing plate without the duct groove pattern part layer (e.g., Patent Document 2).

Furthermore, the third method is a method in which a woodgrain pattern is printed on a colored film, a transparent film is bonded thereon, a pattern such as a duct groove pattern is embossed on a surface using an embossing plate to form a depressed part, and further, a valley print is applied to the depressed part by a wiping technique, and a transparent or semi-transparent surface protection layer is formed on the entire surface by a gravure printing process.

By the way, there have been growing requests of consumers for decorative sheets, and a soft finish, in which a visual embossing effect is expressed by surface finish, or there are substantially projections and depressions and a part other than duct grooves is also a soft matt-finished surface and a woody feeling is expressed as a touch sensation, is preferred.

Further, from the viewpoint of the quality of the decorative sheet, a decorative sheet, which is superior in abrasion resistance, scratch resistance and organic solvent resistance and can maintain the matt feeling for a prolonged period of time, ensuring excellent durability, is desired.

On the other hand, there is proposed a matt decorative material which has good scratch resistance by virtue of a surface protection layer formed from a coating material containing beads which has been previously used for expressing a suede feeling. Further, as a method for forming projections and depressions on the surface protection layer, a common heat embossing method and a casting method on a shaped sheet are proposed (e.g., Patent Document 3).

### Patent Document 1: Japanese Unexamined Patent Publication (JP-A) No. 52-38002

### Patent Document 2: Japanese Patent Publication No. 2884842

### Patent Document 3: JP-A No. 6-79831

### DISCLOSURE OF THE INVENTION

### Problems to be Solved by the Invention

However, the decorative sheets fabricated by the first and second methods proposed for satisfying such requests can express a desired part such as a duct pattern part as a depressed part as visual and touch sensations, but the decorative sheets are inadequate for soft finishing by which a woody feeling is expressed as a touch sensation of parts other than the desired part such as a duct pattern part.

Further, in the decorative sheet formed by the third method, since embossing is performed using an embossing plate to form a depressed part, and then a valley print is applied to the depressed part with ink by a wiping technique, all depressed parts have the same color tone, and therefore, it is difficult to satisfy the requests of consumers in excellent design and a touch sensation of other parts, nor embossed, cannot be expressed.

Further, also in the decorative sheet using a bead pigment of Patent Document 3 described above, a heat embossing machine or facilities for the casting method is required as a processing machine beside a gravure printing machine although it is proposed that a surface protection layer containing a bead pigment is provided on a woodgrain pattern layer, and the projection and depression to express projections and depressions, such as a grained duct groove, of the surface of a grained plate on the surface protection layer can be formed by a heat embossing method or a casting method on a shaped sheet are proposed.

Accordingly, it is an object of the present invention to provide a precoated decorative sheet with an excellent design by gravure printing, which has a surface superior in abrasion resistance, scratch resistance and organic solvent resistance, and is endowed with a touch sensation of a natural wood coated with a matt coating material and a visual woody feeling like a natural wood, and which has a woodgrain pattern of reproducing an adequate sensation of unevenness.

### Means for Solving the Problems

In order to solve the problems described above, in a decorative sheet provided with a protective layer mainly composed of a transparent resin component provided on the surface of a print layer of a print sheet, the invention of claim 1 employs a constitution in which the above described protective layer is made of a first protective layer provided on the print layer of the print sheet and a second protective layer containing transparent or semi-transparent spherical particles and provided on given areas of the first protective layer, and the luster of the salient surface of the first protective layer is lower than the luster of the surface of the second protective layer.

Next, in a decorative sheet using a film or colored film formed by providing a print layer and a hiding layer in this order on a back side of a transparent or semi-transparent film and providing a protective layer mainly composed of a transparent resin component on the surface of the film, the invention of claim 2 employs a constitution in which the above described protective layer is made of a first protective layer and a second protective layer containing transparent or semi-transparent spherical particles and provided on given areas of the first protective layer and the luster of the salient surface of the first protective layer is lower than the luster of the surface of the second protective layer.

In the invention of claim 1 or 2, a print layer refers to a layer on which a pattern having a design such as a woodgrain pattern is printed and the pattern is not limited to the woodgrain pattern, and the print layer includes layers on which various patterns are printed, such as layers on which projections and depressions or a metal surface is expressed using various geometrical patterns or shading patterns, and further includes pattern-free layers printed with a single color.

In the invention of claim 2, the colored film refers to a film colored by previously kneading a coloring agent such as pigment in a film or performing printing on the surface of the film in place of providing a print layer and a hiding layer on a back side of a transparent or semi-transparent film

In the invention of claim 1 or 2, examples of the transparent or semi-transparent spherical particles include particles using fine resin beads or inorganic beads, and examples of the resin beads include resin spherical beads of transparent organic compound such as acrylic resin beads, polyurethane resin beads, polyethylene resin beads, polystyrene resin beads, melamine resin beads, and the like, and examples of inorganic beads include spherical particle beads of transparent inorganic material such as alumina or silica powder, glass particle, and the like.

In addition, the spherical particle is limited to a transparent or semi-transparent particle in order to have no effect on the color of the print layer or the colored film below the protective layer.

Further, the given area of the first protective layer on which the second protective layer is provided refers to a projection part of projection and depression expressions intended to exhibit at the surface of the decorative sheet, and for example, in the case of the woodgrain pattern, the given area is an area, with which, in order to express a depressed part of a duct groove, a depressed part of an annual ring pattern and a depressed part of a fine fiber texture, a register is aligned, other than the above-mentioned pattern of the print layer for providing the second protective layer. However, the given area does not necessarily require coinciding with the pattern of the print layer and a random expression of projections and depressions not coinciding with the pattern may be employed. In short, although the pattern of the print layer does not coincide with the projections and depressions due to providing the second protective layer, a real feeling is adequately expressed by a visual pattern and a touch sensation (due to projections and depressions).

Further, in the invention of claim 1 or 2, that the luster of the salient surface of the first protective layer is lower than the luster of the surface of the second protective layer refers to a state in which there is a difference in the surface luster between a depressed part being a part of the first protective layer, which is not covered with the second protective layer and comes out of the second protective layer, and a projected part being a surface of the second protective layer, and the luster of the depressed part is lower than the luster of the projected part. This state can be achieved by appropriate means, for example, by producing a difference in the luster through a difference in the luster between resins, not containing a matting agent, in the first protective layer and in the second protective layer, or through different amounts of the resins applied to express higher luster of the second protective layer than that of the first protective layer, or by including a matting agent only in the first protective layer or adjusting the materials or amounts of the matting agents contained in the first protective layer and the second protective layer to make the first protective layer more matter than the second protective layer.

Next, the invention of claim 3 is the decorative sheet adjusted in such a way that the depth of a gravure printing plate to form the second protective layer is 45 to 120 μm, an average particle diameter of the spherical particles is 5 to 40 μm, and the content of the spherical particle is 10 to 150 parts by weight per 100 parts by weight of a resin composition being a main component of the second protective layer.

Furthermore, in the inventions of claims 1 to 3, a sheet of quality of excellent solvent resistance could be obtained by using a reactive curable resin or an ultraviolet ray/electron beam curable resin for resins of the first protective layer and the second protective layer containing spherical particles to improve scratch resistance.

As a composition of the reactive curable resin that is a main component of the first protective layer and the second protective layer, a product made from acrylpolyol or polyester polyol and polyisocyanate, or a substance formed by adding a catalyst such as p-toluenesulfonic acid to an aminoalkyd resin is used. Naturally, a plasticizer, a stabilizer, a dispersant, a matting agent, or a diluent may be added.

Herein, the print sheet in claim 1 is formed by using an opaque decorative sheet as a substrate and providing a hiding solid layer and a print layer on the substrate, and a first protective layer is provided on the print layer and a second protective layer containing transparent or semi-transparent spherical particles is provided on given areas of the first protective layer.

Additionally, as the print sheet in claim 2, a film formed by using a transparent or semi-transparent film as a substrate and providing a print layer and a hiding solid layer in this order on the back side of the substrate, or a colored film that is already colored from the beginning, that is, at a stage of a substrate is used, and a first protective layer is provided on the surface of the film above the print layer and a second protective layer containing transparent or semi-transparent spherical particles is provided on given areas of the first protective layer.

In accordance with the present invention, by the first and second protective layers, the surface of the decorative sheet becomes excellent in abrasion resistance, scratch resistance and organic solvent resistance, and in the case of the decorative sheet having a wood-grain print layer, the decorative sheet is finished like a natural wood coated with a matt coating material and a touch sensation and a visual woody feeling comes closer to a natural wood, and furthermore a visual sensation of unevenness and a bump as a touch sensation between a part of the first protective layer on which the second protective layer does not exist and a part of the first protective layer on which the second protective layer exists, and a bump of projection and depression produced by a projection of the spherical particle in the second protective layer containing spherical particles are adequately achieved, and fine projections and depressions having bumps of various sizes are produced, and therefore a woodgrain pattern of an excellent design, which has a woodgrain pattern of reproducing various sensations of unevenness, can be exhibited.

That is, since the sheet obtained in the present invention contains transparent or semi-transparent spherical particles in the second protective layer, it has a soft matt surface and can attain a soft appearance by a lens effect, and furthermore. since the surface of the second protective layer has fine projections and depressions, a highly designed sheet whose touch sensation is very close to that of a material was obtained.

Furthermore, since the part of the first protective layer with no the second protective layer is a depressed part and the luster of the salient surface of the first protective layer at the depressed part is lower than the luster of the second protective layer, the depressed part is more matte than a projected part and the visual sensation of unevenness is attained by the difference in the luster between the depressed part and the projected part.

In addition, with respect to the gloss level of the entire surface of the decorative sheet, generally, when a gloss value (incident angle)60° measured by “Specular glossiness—Method of measurement” according to JIS Z 8741 is about 40 or less, preferably 20 or less, the decorative sheet imparts a soft matt feeling, and when a gap is made between the gloss value of a part of the salient first protective layer and the gloss value of the second protective layer, a sensation of unevenness is visually expressed, but if a difference in gloss value is too large, a soft feeling cannot be expressed and the difference in gloss value is preferably 01 to 20.

Furthermore, in the case of a fibrous substrate such as paper, the first protective layer has an effect of preventing the spherical particles, which are contained in and project from the second protective layer, from being buried due to the so-called uneven formation that absorbency inherent in the fibrous substrate varies from area to area due to a reactive curable resin applied so that the spherical particles are stabilized, and the touch sensation resulting from projections and depressions and the stability of an effect of matting are improved. Additionally, the first protective layer has an effect of securing physical properties which are abrasion resistance, scratch resistance and solvent resistance of parts of the first protective layer coming out to the surface, that is, parts of the first protective layer on which the second protective layers do not exist.

### BEST MODE FOR CARRYING OUT THE INVENTION

Hereinafter, embodiments of the present invention will be described according to accompanying drawings.

As shown in FIG. 1, in the decorative sheet 1, an opaque decorative paper 2 is used as a substrate, and a hiding solid layer 3 and a wood-grain print layer 4, for example, formed by using a normal ink using a nitrocellulose resin, a urethane resin, an acrylic resin, a vinyl chloride-vinyl acetate copolymer or a polyester resin as a binder are provided on the decorative paper 2 by a gravure printing machine to form a print sheet 5.

Examples of the decorative paper 2 include a tissue paper, a strong fiber paper, a saturated paper, a synthetic paper, a colored polyester film, a colored vinyl chloride film, a colored olefin film, and aluminum foil.

In addition, when the colored ink to form the wood-grain print layer 4 is formed from an ink containing glorious pigment such as inks of pearl pigment, metal powder or the like, the gloss inherent in grains of a grained plate, namely, the “brightness” is expressed, inducing more a woody feeling of a natural wood.

Furthermore, the decorative sheet 1 has a structure in which a first protective layer 7 appropriately containing a matting agent and a second protective layer 9 appropriately containing a matting agent and spherical particles 8 are provided as a protective layer 6 on the surface of the print sheet 5.

The first protective layer 7 is provided by applying printing in a given thickness onto the wood-grain print layer 4 of the print sheet 5, and the second protective layer 9 is provided by using a printing plate of a desired woodgrain pattern having a duct groove pattern part and other none-pattern parts and applying printing onto the first protective layer 7 aligning the second protective layer with a given area of a woodgrain pattern of the wood-grain print layer 4 of the print sheet 5.

Materials of the first protective layer 7 and the second protective layer 9 is a reactive curable resin to form a coat of high strength and these protective layers are mainly composed of an aminoalkyd resin, an unsaturated polyester resin, an epoxy resin, a urethane resin, or an acrylic resin, and resins of both protective layers may be the same or may be different.

In the first protective layer, a matting agent is appropriately added to the resin described above, and as the matting agent, common inorganic fine powder such as conventional silica, calcium carbonate, barium sulfate, clay, talc, or the like may be used.

The second protective layer 9 is also formed by adding the spherical particles 8 to the resin described above. The spherical particle referred to herein may be a particle whose outside shape is nearly spherical such as an oval figure having a small eccentricity or a polyhedron having many sides or rounded-corners. If the spherical particles are nonangular particles, a ratio of damaging a doctor blade in applying a resin by a gravure printing process is small, and the surface of the resulting decorative sheet is superior in the scratch resistance and the abrasion resistance for scratch and scuff, and achieves resistance to falling out of the particles and a surface shape hardly varies.

As the spherical particle 8, an acrylic resin particle, a urethane resin particle, an alumina particle, a melamine particle or a bead of silica or the like is used and a true sphere having an average particle diameter of 5 to 40 μm is preferably used, and in the second protective layer 9, the content of the spherical particle 8 is set at 10 to 150 parts by weight per 100 parts by weight of a resin composition being a main component of the second protective layer 9 and the spherical particle 8 is partially projected from the surface of the second protective layer 9.

In order to further improve the scratch resistance and the abrasion resistance of the first protective layer and the second protective layer, it is effective to impart a lubricating property to a resin by the addition of a slip agent. The slip agent may be appropriately selected from fatty acid derivatives such as fatty acid amide, higher fatty acids and the like, olefin waxes and silicone oils and may be added in an amount of about 0.1 to 5 parts by weight per 100 parts by weight of the resin composition being a main component.

Further, for example, in the case of the woodgrain pattern, since, as the second protective layer, a gravure printing plate, in which a desired woodgrain pattern having a duct groove pattern part, a fine fiber pattern part and other none-pattern parts is provided and the depth of the gravure printing plate is 45 to 120 μm, is used and the second protective layer 9 is printed on the first protective layer 7 having lower luster than the second protective layer aligning the second protective layer with a given area of the wood-grain print layer 4 of the print sheet 5, a woodgrain pattern of an excellent design, in which a visual sensation of unevenness based on a difference in the luster between the first protective layer and the second protective layer and a sensation of unevenness based on a bump produced by a thickness of the second protective layer 9 and a projection of the spherical particle 8 from the surface are respectively reproduced, can be exhibited.

The decorative sheet 1 thus fabricated is used in decoration of the surfaces of interior material and fixture of buildings such as houses, building materials such as joinery products, furniture and fittings, household equipment, home electric appliances, etc., and the decorative sheet 1 imparts a visual sensation of unevenness and a soft matt feeling with a soft unevenness feeling as a touch sensation, and a in order to express amore real woody feeling, and in addition it is superior in abrasion resistance, scratch resistance and organic solvent resistance and can maintain the matt feeling for a prolonged period of time, ensuring excellent durability.

FIG. 2 shows an embodiment of a decorative sheet using a transparent film as a substrate.

As shown in FIG. 2, the decorative sheet 1′ has a structure in which a transparent film 10 is used as a substrate, and a wood-grain print layer 4 formed by appropriately selecting, a normal colored ink using a urethane resin, an acrylic resin, a vinyl chloride-vinyl acetate copolymer resin or a polyester resin as a binder and a hiding solid layer 3 are provided on the back side of the transparent film 10 by a gravure printing machine to form a print film 11, and a first protective layer 7 containing a matting agent and a second protective layer 9 containing spherical particles 8 are provided as a protective layer 6 on the surface of the substrate of the print film 11.

Examples of the transparent film 10 include a polyester film, a vinyl chloride film, an olefin base film and the like.

The first protective layer 7 is provided by applying printing in a given thickness onto the print film 11 and the second protective layer 9 is provided by using a printing plate of a desired woodgrain pattern having a duct groove pattern part, a fine fiber texture pattern part and other none-pattern parts and applying printing onto a given area on the first protective layer 7, which corresponds to a woodgrain pattern of the aforementioned wood-grain print layer 4 of the print film 11.

In addition, the constitutions, materials, thicknesses and printing means of the first protective layer 7, the second protective layer 9 and the spherical particle 8 are substantially similar to the embodiment of FIG. 1 and the descriptions thereof are omitted.

As with the decorative sheet 1′ of FIG. 1, the decorative sheet 1′ of this embodiment has a surface superior in abrasion resistance, scratch resistance and organic solvent resistance and can achieve a finished surface with a visual soft feeling by a state, in which a natural wood is subjected to matt coating which is uneven and soft as visual and touch sensations, and the lens effect of the spherical particles.

Further, the decorative sheet 1′ thus fabricated is used in decoration of the surfaces of interior material and fixture of buildings such as houses, building materials such as joinery products, furniture and fittings, household equipment, home electric appliances, etc., and the decorative sheet 1′ imparts a soft matt feeling with a sensation of unevenness as visual and touch sensations on its surface, and is superior in abrasion resistance, scratch resistance and organic solvent resistance and can maintain the matt feeling for a prolonged period of time, ensuring excellent durability.

### Example 1

Wood-grain printing (substrate solid plate, texture plate, tone plate, duct plate) was applied onto a tissue paper having a basis weight of 30 g/m² with a nitrocellulose base normal ink according a gravure printing method. A pearl pigment ink comprising mica was used in the texture pattern plate. A two-component curable acrylic-urethane resin formed by adding polyisocyanate to acrylpolyol was applied to the whole surface of the printed tissue paper as a first protective layer in such way that a gloss value of the protective layer was 10 and an application amount of the protective layer was 3 g/m² after drying, and a resin coating material of the following composition, containing transparent resin beads, was applied to a position of the above-mentioned pattern part as a second protective layer with a printing plate without a duct pattern part and a fine fiber texture part having a depth of 90 μm, and then the resin coating material was dried and the resulting decorative sheet was rolled up.

A gloss value of the second protective layer was 18 to 20 and this decorative paper was left standing for 3 days in a state of being taken up in a curing room kept at 60° C. to cure the resin for the enhancement and acceleration of the adhesion between the layers, the acceleration of resin curing and the prevention of resin blocking and obtain a decorative paper being a decorative material of the present invention.

### [Composition of Transparent Print Coating Material]

| | | |
|---|---|---|
| (1) | Transparent cross-linked acrylic resin bead | 25 parts |
| | (average particle diameter 30 μm) | |
| (2) | Binder (polyester polyol resin/acrylpolyol resin) | 20 parts |
| (3) | Slip agent (silicone oil) | 1 part |
| (4) | Hardener (hexamethylene diisocyanate prepolymer) | 20 parts |
| (5) | Anti-blocking agent (amide-based wax) | 1 part |
| (6) | Solvent (ethyl acetate, butyl acetate) | 50 parts |

### Example 2

By a duplex printing machine in a gravure printing process, leather texture printing with a wrinkle groove pattern (pattern plate, substrate solid plate) was applied onto the back side of a transparent olefin film having a thickness of 0.1 mm with a normal urethane base ink, and after reversing the film, a two-component curable acrylic-urethane resin formed by adding polyisocyanate to transparent acrylpolyol including a matting agent mixed was applied to the whole area of a matte film surface subjected to an unevenness-processing as a first protective layer in such way that a gloss value of the protective layer was 01 and an application amount of the protective layer was 2 g/m² after drying, and a resin coating material of the following composition, containing transparent resin beads, was applied as a second protective layer with a printing plate without a wrinkle groove pattern having a depth of 70 μm with a register aligned with the wrinkle groove pattern part, and then the resin coating material was dried and the resulting decorative sheet was rolled up.

A gloss value of the second protective layer was 06 to 07, and this decorative sheet was left standing for 5 days in a curing room kept at 20° C. to cure the sheet for the enhancement and acceleration of the adhesion between the layers, the acceleration of resin curing and the prevention of resin blocking and obtain a decorative sheet being a decorative material of the present invention.

### [Composition of Transparent Matt Print Coating Material]

| | | |
|---|---|---|
| (1) | Transparent melamine resin bead (average | 20 parts |
| | particle diameter 10 μm) | |
| (2) | Matting agent (silica, average particle | 2 parts |
| | diameter 1.5 μm) | |
| (3) | Binder (acrylpolyol resin) | 18 parts |
| (4) | Hardener (hexamethylene diisocyanate | 10 parts |
| | prepolymer) | |
| (5) | Solvent (ethyl acetate, butyl acetate) | 40 parts |

### Example 3

By a gravure printing process, wood-grain printing (pattern plate, substrate solid plate) was applied onto the back side of a vinyl chloride resin film (content of a plasticizer 20 parts by weight) having a thickness of 0.1 mm with a vinyl chloride-vinyl acetate copolymer ink and the resulting film was taken up. By a gravure printing machine again, a two-component curable acrylic-urethane resin formed by adding polyisocyanate to acrylpolyol including a matting agent mixed was applied to the whole area of a surface as a first protective layer in such way that a gloss value of the protective layer was 04 and an application amount of the protective layer was 2 g/m² after drying, and a resin coating material of the following composition, containing transparent resin beads, was applied to given areas as a second protective layer with a printing plate without a quarter-sawn duct pattern and a fine fiber texture part, having a depth of 60 μm, and then the resin coating material was dried and the resulting decorative sheet was rolled up.

A gloss value of the second protective layer was 20 and this decorative sheet was left standing in a curing room as with Example 2 to obtain a decorative sheet being a decorative material of the present invention.

### [Composition of Transparent Matt Print Coating Material]

| | | |
|---|---|---|
| (1) | Transparent cross-linked acrylic resin | 20 parts |
| | bead (average particle diameter 12 μm) | |
| (2) | Matting agent (silica, average particle | 2 parts |
| | diameter 2 μm) | |
| (3) | Binder (acrylpolyol resin) | 18 parts |
| (4) | Hardener (xylylene diisocyanate) | 10 parts |
| (5) | Solvent (ethyl acetate, butyl acetate) | 40 parts |

### BRIEF DESCRIPTION OF THE DRAWINGS

FIG. 1 is an enlarged longitudinal sectional view of a decorative sheet.

FIG. 2 is an enlarged longitudinal sectional view of another decorative sheet.

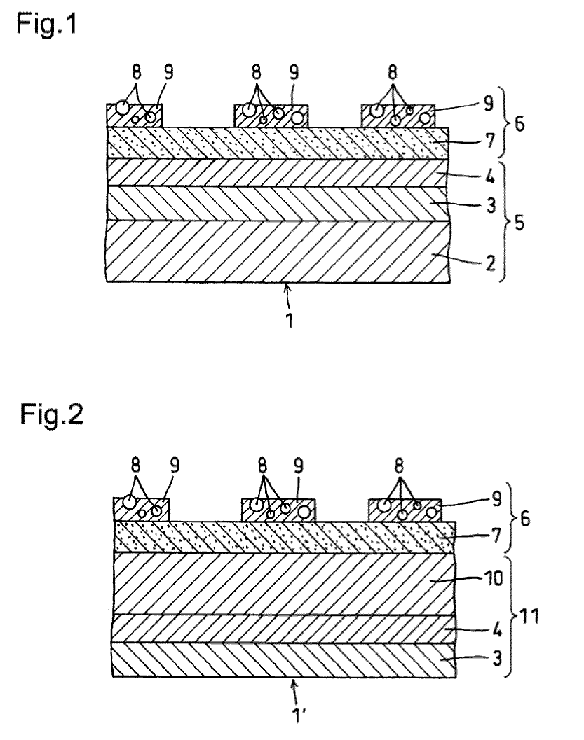

### DESCRIPTION OF THE REFERENCE NUMERALS AND SYMBOLS

1 decorative sheet
2 decorative paper
3 hiding solid layer
4 wood-grain print layer
5 print sheet
6 protective layer
7 first protective layer
8 spherical particle
9 second protective layer
10 transparent film
11 print film

1. A decorative sheet provided with a protective layer mainly composed of a transparent resin component provided on the surface of a print layer of a print sheet, wherein the protective layer comprises a first protective layer provided on the print layer of the print sheet and a second protective layer containing transparent or semi-transparent spherical particles and provided on given areas of the first protective layer, and the luster of the salient surface of the first protective layer is lower than the luster of the surface of the second protective layer.

2. A decorative sheet, using a film or colored film formed by providing a print layer and a hiding layer in this order on a back side of a transparent or semi-transparent film and providing a protective layer mainly composed of a transparent resin component on the surface of the film, wherein the protective layer comprises a first protective layer and a second protective layer containing transparent or semi-transparent spherical particles and provided as required on given areas of the first protective layer and the luster of the salient surface of the first protective layer is lower than the luster of the surface of the second protective layer.

3. The decorative sheet according to claim 1, wherein a depth of a gravure printing plate to form the second protective layer is 45 to 120 μm, an average particle diameter of the spherical particles is 5 to 40 μm, and the content of the spherical particle is 10 to 150 parts by weight per 100 parts by weight of a resin composition being a main component of the second protective layer.

4. The decorative sheet according to claim 2, wherein a depth of a gravure printing plate to form the second protective layer is 45 to 120 μm, an average particle diameter of the spherical particles is 5 to 40 μm, and the content of the spherical particle is 10 to 150 parts by weight per 100 parts by weight of a resin composition being a main component of the second protective layer.
